(19) United States
(12) Patent Application Publication
(10) Pub. No.: US 2015/0188391 A1
(43) Pub. Date: Jul. 2, 2015

(54) APPARATUS FOR COOLING AN ELECTROMAGNETIC MACHINE

(71) Applicant: Boulder Wind Power, Inc., Louisville, CO (US)

(72) Inventors: William S. Carron, Louisville, CO (US); Kirk Pierce, Lafayette, CO (US)

(73) Assignee: Boulder Wind Power, Inc., Louisville, CO (US)

(21) Appl. No.: 14/145,360

(22) Filed: Dec. 31, 2013

(51) Int. Cl. H02K 9/00; F28F 3/12

(52) U.S. Cl. CPC H02K 9/00; F28F 3/12

(57) ABSTRACT

Apparatus and methods are described herein for providing a cooling system for an electromagnetic machine. In some embodiments, an apparatus includes a structure for an electromagnetic machine including a first outer support member that is configured to support a conductive winding or a magnet and a second support member that is disposed at a non-zero distance from the first support member. An elongate structural member has a first end coupled to the first support member and a second end coupled to the second support member and extends between the first support member and the second support member. The elongate structural member defines an interior channel that extends between the first end and the second end of the elongate structural member. The channel is configured to convey a cooling medium therethrough to cool at least a portion of the electromagnetic machine.

### BACKGROUND

Some embodiments described herein relate to electromagnetic machines and more particularly to dual-function structural and cooling elements for an electronic machine.

Permanent magnet electromagnetic machines (referred to as “permanent magnet machines” or “electromagnetic machines” herein) utilize magnetic flux from permanent magnets to convert mechanical energy to electrical energy or vice versa. Various types of permanent magnet machines are known, including axial flux machines, radial flux machines, and transverse flux machines, in which one component rotates about an axis or translates along an axis, either in a single direction or in two directions (e.g., reciprocating, with respect to another component). Such machines typically include windings to carry electric current through coils that interact with the flux from the magnets through relative movement between the magnets and the windings. In a common industrial application arrangement, the permanent magnets are mounted for movement (e.g., on a rotor or otherwise moving part) and the windings are mounted on a stationary part (e.g., on a stator or the like). Other configurations, typical for low power, inexpensive machines operated from a direct current source where the magnets are stationary and the machine's windings are part of the rotor (energized by a device known as a “commutator” with “brushes”) are also available, but will not be discussed in detail in the following text in the interest of brevity.

In an electric motor, for example, current is applied to the windings in the stator, causing a force or torque between the rotor and stator (e.g., causing the magnets and therefore the rotor to move relative to the windings), thus converting electrical energy into mechanical energy. In a generator, application of an external force to the generator's rotor causes the magnets to move relative to the windings, and the resulting generated voltage causes current to flow through the windings—thus converting mechanical energy into electrical energy. In an AC induction motor, the rotor is energized by electromagnetic induction produced by electromagnets that cause the rotor to move relative to the windings on the stator, which are connected directly to an AC power source and can create a rotating magnetic field when power is applied.

In operation, the rotor and/or the stator can be subject to significant heating, which may necessitate active or passive cooling. In large electromagnetic machines, cooling ducts, particularly thin wall cooling ducts disposed exterior to structural members, can be subject to damage during installation, maintenance, ice and/or snow loading, and/or high winds. In addition, ducting disposed around the rotor and/or stator can reduce the efficiency of a fluid-driven turbine by contributing to the drag loading of the structure. Furthermore, the driving mechanism for a cooling mechanism can contribute mass and/or mechanical complexity to the active section of the machine.

Thus, a need exists for improved apparatus and methods to increase the structural efficiency of an electromagnetic machine and/or improve the ability of the electromagnetic machine to provide cooling functions without an increase in components to the electromagnetic machine.

### SUMMARY

Apparatus and methods are described herein for providing a cooling system for an electromagnetic machine. In some embodiments, an apparatus includes a structure for an electromagnetic machine including a first support member that is configured to support a conductive winding or a magnet and a second support member that is disposed at a non-zero distance from the first support member. An elongate structural member has a first end coupled to the first support member and a second end coupled to the second support member and extends between the first support member and the second support member. The elongate structural member defines an interior channel that extends between the first end and the second end of the elongate structural member. The channel is configured to convey a cooling medium therethrough to cool at least a portion of the electromagnetic machine.

### BRIEF DESCRIPTION OF THE DRAWINGS

FIG. 1 is a schematic illustration of a generator structure, according to an embodiment.

FIG. 2 is a front view illustration of a portion of a generator structure, according to an embodiment.

FIG. 3A is a perspective view of a portion of a generator structure, according to an embodiment.

FIG. 3B is a cross-sectional view of the portion of the generator structure of FIG. 3A.

FIG. 4A is a perspective view of a portion of a generator structure, according to an embodiment.

FIG. 4B is a cross-sectional view of the portion of a generator structure of FIG. 4A.

FIG. 5 is a front view of a portion of a generator structure, according to another embodiment.

FIGS. 6 and 7 are each a schematic cross-sectional view of a structural member, according to different embodiments.

FIG. 8A is a cross-sectional view of a structural member, according to another embodiment; and FIG. 8B is a cross-sectional view taken along line 8B-8B in FIG. 8A.

FIG. 9A is a cross-sectional view of a structural member, according to yet another embodiment; and FIG. 9B is a cross-sectional view taken along line 9B-9B in FIG. 9A.

### DETAILED DESCRIPTION

Some embodiments described herein relate to a structure for an electromagnetic machine having an outer support member and an inner support member. The outer support member can include a conductive winding and/or a magnet. An elongated structural member can be substantially radially disposed between the outer support member and the inner support member and can define a channel configured to convey a cooling medium to cool at least a portion of the electromagnetic machine.

In some embodiments, an apparatus includes a structure for an electromagnetic machine including a first support member that is configured to support a conductive winding or a magnet and a second support member that is disposed at a non-zero distance from the first support member. An elongate structural member has a first end coupled to the first support member and a second end coupled to the second support member and extends between the first support member and the second support member. The elongate structural member defines an interior channel that extends between the first end and the second end of the elongate structural member. The channel is configured to convey a cooling medium therethrough to cool at least a portion of the electromagnetic machine. In some embodiments, the second support member is disposed radially spaced from the first support member and the structural member extends radially between the first support member and the second support member.

In some embodiments, an apparatus includes a structure for an electromagnetic machine that includes a first support member configured to support a conductive winding or a magnet and a second support member disposed at a non-zero distance from the first support member. An elongate structural member has a first end coupled to the first support member and a second end coupled to the second support member and extends between the first support member and the second support member. The elongate structural member defines a first interior channel extending between the first end and the second end of the elongate structural member and a second interior channel in fluid communication with the first interior channel that extends between the first end and the second end of the elongate structural member. The first interior channel is configured to convey a cooling medium in a first radial direction and the second interior channel is configured to receive the cooling medium from the first interior channel and convey the cooling medium in a second radial direction opposite the first direction. The cooling medium is configured to cool at least a portion of the electromagnetic machine. In some embodiments, the second support member is disposed radially spaced from the first support member and the structural member extends radially between the first support member and the second support member.

In some embodiments, an apparatus includes a structural cooling device for an electromagnetic machine that includes an elongate structural member having a first end couplable to an inner support member of the electromagnetic machine, and a second end couplable to an outer support member of the electromagnetic machine. The elongate structural member extends radially between the inner support member and the outer support member and is configured to resist at least one of radial, axial or rotational deflection of the outer support member relative to the inner support member when coupled thereto. The elongate structural member defines an interior channel extending between the first end and the second end of the elongate structural member and configured to receive a cooling medium therethrough. A source of cooling medium is couplable to the elongate structural member and configured to convey the cooling medium to the interior channel of the elongate structural member. The cooling medium is configured to cool at least a portion of the electromagnetic machine.

Electromagnetic machines as described herein can be various types of synchronous and asynchronous machines, such as wound field synchronous machines, induction machines, doubly fed induction machines (presently commonly found in the wind energy conversion market), permanent magnet machines, including axial flux machines, radial flux machines, and transverse flux machines, in which one component rotates about an axis or translates along an axis, either in a single direction or in two directions (e.g., reciprocating, with respect to another component). Such machines typically include windings to carry electric current through coils that interact with the flux from the magnets through relative movement between the magnets and the windings. In a common industrial application arrangement (including the embodiments described herein), the permanent magnets are mounted for movement (e.g., on a rotor or otherwise moving part) and the windings are mounted on a stationary part (e.g., on a stator or the like). Some embodiments described herein focus on the permanent magnet variety of electromagnetic machines.

Although the embodiments described herein are described with reference to use within an electromagnetic machine (e.g., a rotor/stator assembly as described herein), it should be understood that the embodiments described herein can also be used within other machines or mechanisms. Furthermore, while described herein as being implemented in or on a stator assembly, it should be understood that the embodiments described herein can be implemented in or on a stator and/or a rotor assembly or another mechanism within an electromagnetic machine having a structural member.

Some embodiments described herein address axial field, air core, surface mounted permanent magnet generator rotor/stator configurations; but it should be understood that the features, functions and methods described herein can be implemented in radial field, transverse field and embedded magnet configurations that employ either an air core or iron core winding configuration. Embodiments described herein can also be applied to electrically excited rotors commonly found in industrial and utility applications, such as wound field synchronous machines and devices common in the wind energy conversion industry known as “doubly fed induction generators.” Furthermore, although the embodiments described herein refer to relatively large electromagnetic machines and/or components such as those found in wind power generators, it should be understood that the embodiments described herein are not meant to limit the scope or implementation of the apparatus and methods to that particular application.

As used herein, the term “axial deflection” can refer to, for example, the deflection (e.g., the bending, swaying, deforming, moving, etc.) of a component in a direction parallel to an axis of rotation of an electromagnetic machine. For example, in a generator having a rotor that is rotatably movable relative to a stator, a component of the stator can be said to have axial deflection when a portion of the component, is moved in a direction along an axis of rotation of the rotor.

As used herein, the term “rotational deflection” can refer to, for example, the deflection (e.g., the bending, swaying, deforming, moving, etc.) of a component in a direction of rotation of an electromagnetic machine. Such deflection can also be referred to as torsional deflection. In instances of large components and structures used in rotating flux machines (e.g., as seen in wind power generators) a small amount of deflection in the rotational direction can be considered tangential deflection near the outer extent of the machine.

As used herein, the term “radial deflection” can refer to, for example, deflection in a direction radially inward toward an axis of rotation of an electromagnetic machine or radially outward from the axis of rotation. For example, an outer support member of a stator or of a rotor can deflect in a radial direction toward an inner support member (e.g., hub) of the stator or rotor.

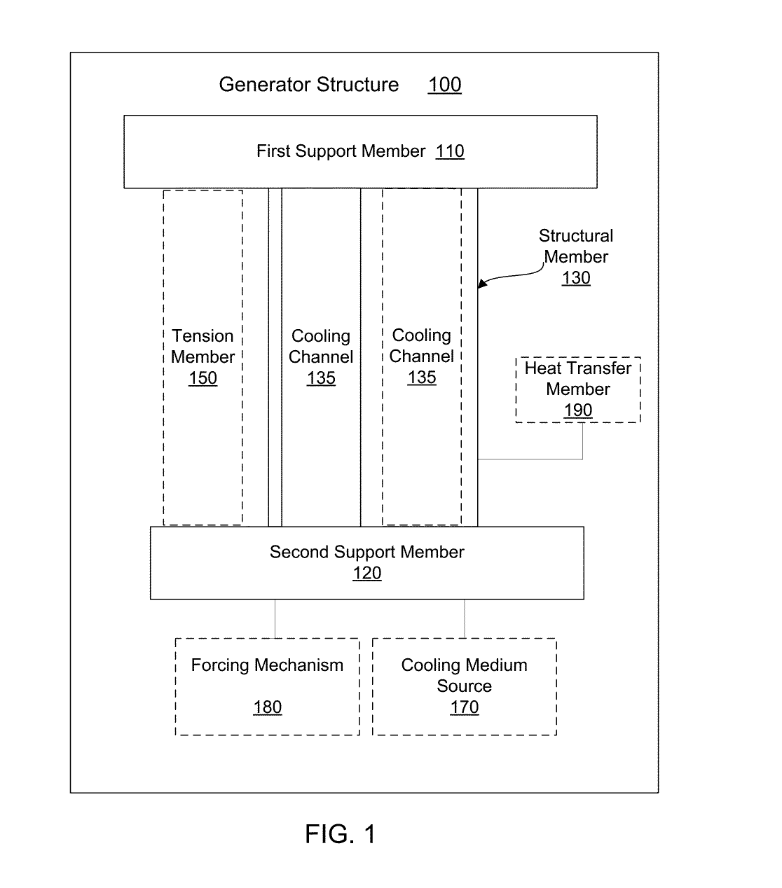

FIG. 1 is a schematic illustration of a generator structure 100, according to an embodiment. The generator structure 100 can be disposed in an electromagnetic machine, such as, for example, an axial flux, radial flux, or transverse flux machine. More specifically, the generator structure 100 described herein can be a stator assembly of, for example, an electric motor or an electric generator that includes a rotor assembly that can move relative to the stator assembly. For example, in some embodiments, the rotor assembly can include a rotor portion that rotates relative to the stator assembly (e.g., rotates with the direction of flux from rotor to stator generally in the axial or radial direction). The stator assembly can include or support, for example, an air core type stator without any ferromagnetic material to support a set of copper windings or conduct magnetic flux. An air core stator can include an annular array of stator segments (not shown) and one or more conductive windings (not shown) or one or more magnets (not shown). Each air core stator segment can include a printed circuit board sub-assembly (not shown), or other means known of structurally encapsulating the windings in non-conductive, or electrically insulating materials. In some embodiments, the printed circuit board sub assemblies can be similar to that described in U.S. Pat. No. 7,109,625, U.S. patent application Ser. No. 13/144,642, and International Application No. PCT/US2010/000112, the disclosure of each of which is incorporated herein by reference in its entirety. In some embodiments, a stator assembly can include or support a conventional iron-core construction arranged similarly to the air core concept described above.

In an alternative embodiment, the generator structure 100 can be a rotor assembly included in an electromagnetic machine. For example, as described above, a rotor assembly can include one or more rotor portions that move relative to a stator. In such embodiments where the generator structure 100 is a rotor assembly, the rotor assembly can include or support one or more magnetic flux generating members, such as, for example, magnets (e.g., a magnet pole assembly, or array of magnets) or windings (each not shown in FIG. 1). In some embodiments, the magnets can include an array of magnets and can be, for example, permanent magnets, electromagnets or a combination of both. For example, in an induction machine or wound field synchronous machine, the magnets are electromagnets. A winding can be, for example, as described above.

As shown in FIG. 1, the generator structure 100 (e.g., a stator assembly) includes a first support member 110 and a second support member 120. The first support member 110 can be any suitable structure or assembly and is configured to support, for example, any number of printed circuit boards (referred to here as “PCBs”) including or encapsulating a set of windings. In use, electrical current flowing through the windings can generate heat.

The second support member 120 can be any suitable structure. For example, in some embodiments, the second support member 120 can be substantially annular and can be configured as a hub, disposed radially inwardly from the first support member 110. In such an arrangement, the first support member 110 may be referred to as an outer support member, and the second support member 120 may be referred to as an inner support member.

The generator structure 100 further includes at least one elongate structural member 130 disposed between the first support member 110 and the second support member 120. In some embodiments, the generator structure 100 can include structural members such as those described in U.S. patent application Ser. No. 13/692,089, entitled “Structure for an Electromagnetic Machine Having Compression and Tension Members,” the disclosure of which is incorporated herein by reference in its entirety. The generator structure 100 can optionally include one or more elongate tension members 150, a forcing mechanism 180 and a source of a cooling medium 170.

The elongate structural member 130 (also referred to herein as “structural member” or “compression member”) can provide structural support to the first support member 110 from the second support member 120. For example, the structural member 130 can include a first end coupled to the first support member 110 and a second end coupled to the second support member 120. For example, in some embodiments, the structural member 130 includes flanged end portions configured to be coupled to the first support member 110 and the second support member 120 (e.g., welded, bolted, riveted, pinned, adhered, or any combination thereof). In some embodiments the structural member 130 can be in compression. The structural member 130 can be formed from any suitable material such as a metal, metal alloy (e.g., steel or steel alloy), and/or composite.

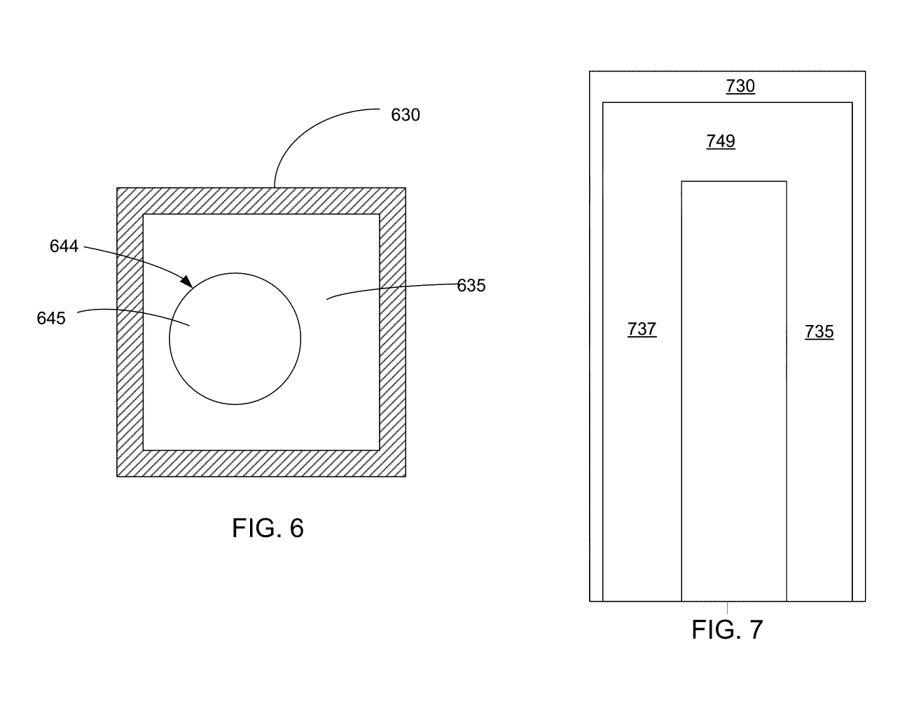

The structural member 130 can also be any suitable shape, size, or configuration. For example, in some embodiments, the structural member 130 can be tubular and define and/or contain one or more cooling channels 135. For example, the structural member 130 can have a cross-section that is square, circular, elliptical, rectangular, oval, etc. In some embodiments, the structural member 130 can be a substantially hollow, closed structure such as, for example, a box tubing (e.g., square or rectangular tubing). The structural member 130 can define a single cooling channel 135 suitable to convey a cooling medium from a first end of the structural member 130 to a second end of the structural member 130 to provide cooling to at least a portion of the electromagnetic machine. In other embodiments, the structural member 130 can include multiple channels. For example, internal structures, such as walls, baffles, tubing, etc., can be disposed within an interior of the structural member 130 and be operable to define one or more cooling channels 135. For example, in such an embodiment, a first channel can deliver or convey the cooling medium in a first direction and the second channel can be a return path for the cooling medium. Such an embodiment can be applied to, for example, a closed loop cooling system described in more detail below. In one such embodiment, the structural member 130 can include one or more longitudinal interior walls that divide the interior region or volume of the structural member 130 into two (or more) cooling channels 135. In another embodiment, the structural member 130 can contain pipes, hoses, and/or tubing suitable to convey a cooling medium (see, e.g., FIG. 6). In some embodiments, a first delivery path can be defined in one structural member 130 of a generator structure and a second return path can be defined in a second structural member 130 (see e.g., the embodiment of FIG. 7). In such an embodiment, a connection channel can be defined between the two structural members such that the cooling medium can flow through the delivery path of the first structural member, through the connection channel and into the return channel of the second structural member.

The optional elongate tension member 150 (also referred to herein as “tension member”) can be any suitable shape, size, or configuration. In some embodiments, the tension member 150 can be a tie rod or a cable such as, for example, a steel braided cable or the like. In some embodiments, the tension member 150 can include a first end portion coupled to a portion of the first support member 110 and a second end portion coupled to a portion of the second support member 120. In some embodiments, the tension member 150 includes a first end portion coupled to a portion of the compression member 130 and a second end portion coupled to the second support member 120. In other embodiments, the first end portion of the tension member 150 can be coupled to a portion of the structural member 130 and the second end portion of the tension member 150 can be coupled to a portion of an adjacent compression member (not shown in FIG. 1).

The structural member 130 and/or the tension member 150 can be collectively configured to substantially increase the structural efficiency and/or increase resistance to deflection of the generator structure 100. For example, in some embodiments, the structural member 130 can be configured to resist axial, radial, and/or rotational deflection of the first support member 110 with respect to the second support member 120. In such embodiments, the cross-sectional shape of the structural member 130 can be configured to resist the deflection. In addition to or alternatively, a force can be applied to the structural member 130 such that the structural member 130 further resists axial and/or radial deflection.

The cooling medium can be, for example, air, water, refrigerant, and/or any other gas, liquid, and/or two-phase coolant that can be conveyed along a length or portion of a length of the support member(s) 130 via the cooling channel(s) 135 of the structural member(s) 130. The cooling medium can reduce the temperature of at least a portion of the generator structure and/or the electromagnetic machine in which the generator structure is disposed. For example, the cooling medium can carry thermal energy away from a portion of the electromagnetic machine to maintain a lower operating temperature than would otherwise be expected without such a cooling medium being introduced into the machine.

The cooling medium can be provided via the source of cooling medium 170. For example, a reservoir or other device can be coupled to the generator structure 130 and be in fluid communication with the cooling channel(s) 135. Alternatively, the cooling medium source 170 may be an inlet, such as an intake that supplies cooling air from the external environment to the cooling channel(s) 135. The forcing mechanism 180 can be fluidically coupled to for example, a first end of the elongate structural member(s) 130 and can be used to increase a flow of the cooling medium within or through the cooling channel(s) 135. The forcing mechanism 180 can be, for example, one or more fans, pumps, compressors or other suitable mechanism to induce or increase a flow of the cooling medium within or through the cooling channel(s) 135. Such components can be, for example, coupled to the rotor of the electromagnetic machine to passively encourage further air flow. In some embodiments, such forcing mechanism(s) 180 can be disposed on or near the first support member 110 or the second support member 120.

The forcing mechanism and/or the source of cooling medium 170 can each be coupled to, for example, the second support member 120, which can reduce the complexity and mass in the active section (e.g., near the windings and/or magnets) of the electromagnetic machine. For example, piping and/or ducting carrying the cooling medium from the source 170 to the cooling channel(s) 135 can be reduced, which can reduce the opportunity for mechanical failure, for example during installation, maintenance, ice and/or snow loading, and/or high winds. For example, in an embodiment where the second support member is an inner support member 120, e.g. includes a central hub and the first support member is an outer support member 110 formed as an annular ring, a centrally disposed forcing mechanism 180 can circulate the cooling medium through the structural member 130 without the need for exterior ducting or piping. In addition, coupling the forcing mechanism to the inner support member 120 can further reduce drag loading of the structure (e.g., of a rotor) which may occur if additional duct surface is exposed to wind loading. In some embodiments, the forcing mechanism 180 can be coupled to a different component of the generator structure 100 and/or the electromagnetic machine in which the generator structure 100 is included.

In some embodiments, the forcing mechanism 180 can be an integral component of the generator structure 100, including such features as airfoils, blades, and/or vanes which can produce a pressure differential as the rotor of the generator structure rotates. Thus, in such an embodiment, a separate forcing mechanism distinct from the generator may not be necessary. In other embodiments, a pressure differential caused by the generator structure 100 can induce a flow through the cooling channel(s) 135 without the use of a forcing mechanism 180.

In some embodiments, the generator structure can include one or more heat transfer members 190 that can be thermally coupled to the elongate structural member(s) 130 and/or to the cooling medium. The heat transfer members 190 can extract heat from the cooling medium and reject it to the external environment. For example, the fluid may be ‘hot’ as it passes through the structural member 130, and can be cooled by the ambient air passing by the structural member 130. The heat transfer members 190 can be, for example, a heat sink, disposed inside or outside the structural member(s) 130, heat pipes extending through an interior of the structural member(s) 130, a feature or component integrally formed with the structural member(s) 130, or a separate component coupled to the structural member(s) 130 that can be formed with the same or different material as the structural member(s) 130.

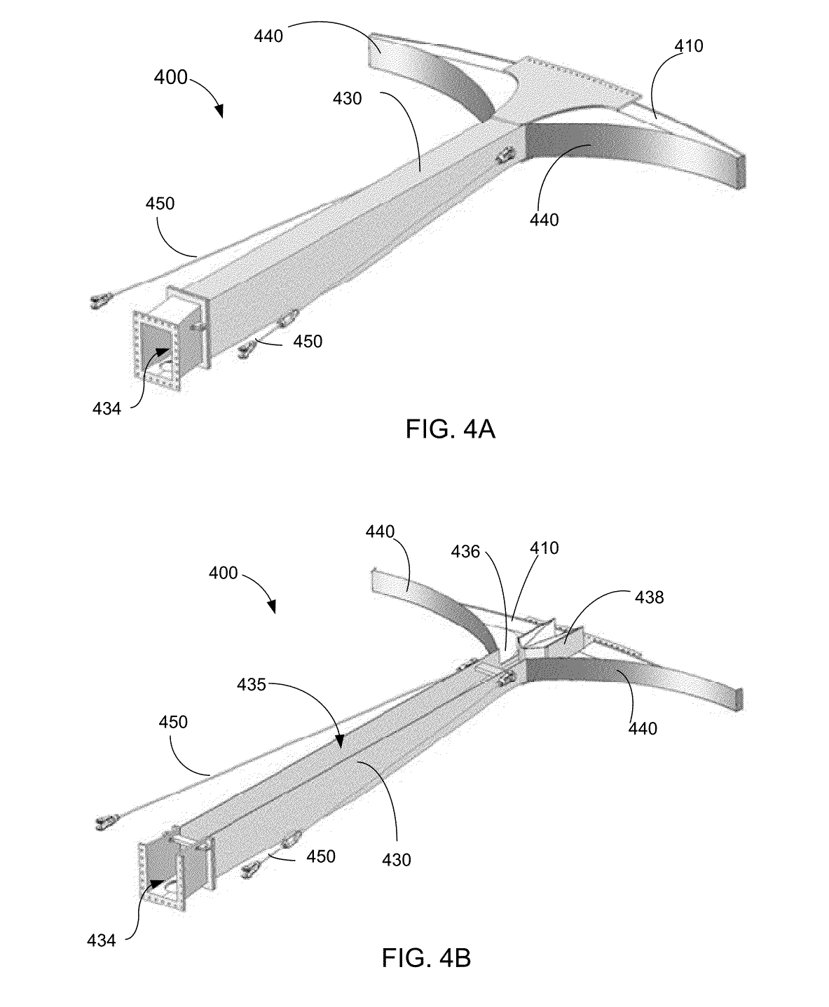

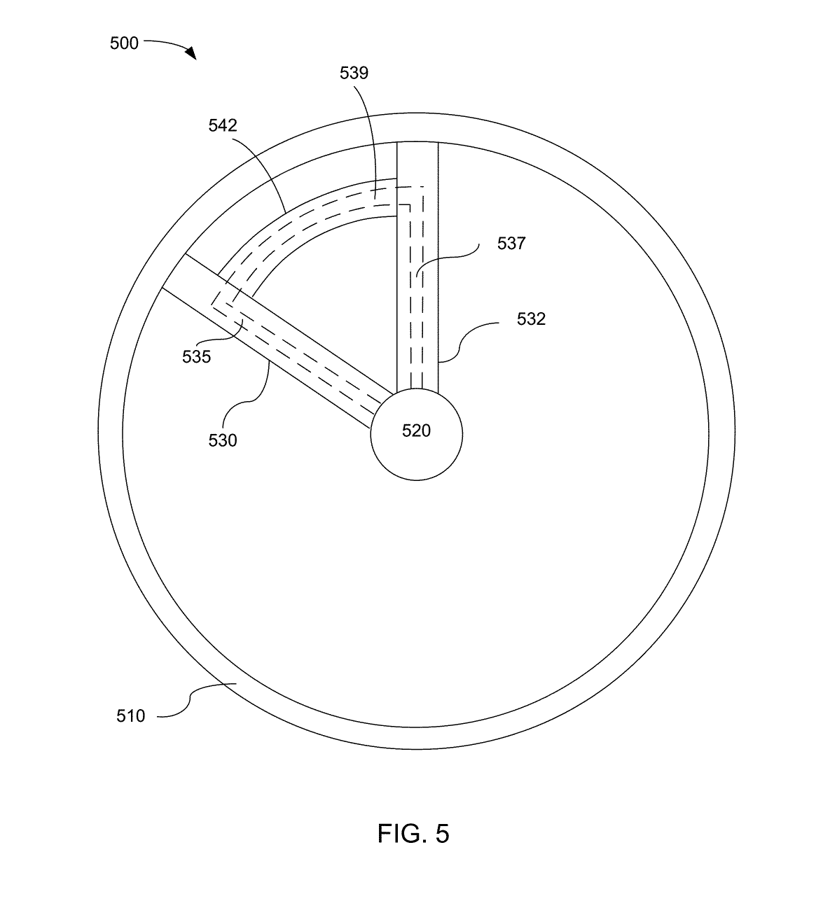

The generator structure 100 can also optionally include a flow guide (not shown in FIG. 1) coupled to the elongate structural member(s) 130, which can direct a flow of the cooling medium entering or exiting the cooling channel(s) 135 and/or direct a flow of the cooling medium within the channel. An embodiment with a flow guide is described below in more detail with reference to FIGS. 4A and 4B.

In some embodiments, the generator structure 100 can include an “open-loop” cooling system, such that the cooling medium can be discharged to the atmosphere. For example, an end portion of the structural member 130 can define an opening in fluid communication with the cooling channel 135 such that the cooling medium can be discharged out through the opening. For example, a cooling medium such as air can be discharged from the structural member 130. In other embodiments, the generator structure 100 can include a “closed-loop” cooling system in which the cooling medium is circulated through one or more structural members 130 and is contained within the cooling system. For example, the cooling medium can circulate from a reservoir (e.g., source of the cooling medium), through the structural member 130 and return to the reservoir. For example, a first cooling channel 135 can carry the cooling medium in a first direction (e.g., towards the first support member 110) and a second cooling channel 135 can carry the cooling medium in a second direction (e.g., away from the first support member 110). Although the direction of flow of the cooling medium is described as flowing in a radial direction from the inner support member 120 towards the outer support member 110, it should be understood that in alternative embodiments, the direction of flow of the cooling medium can be from the outer support member 110 radially inward towards the inner support member 120. In some embodiments, an “open-loop” cooling system can also include a return path or channel to provide an exhaust path for the cooling medium.

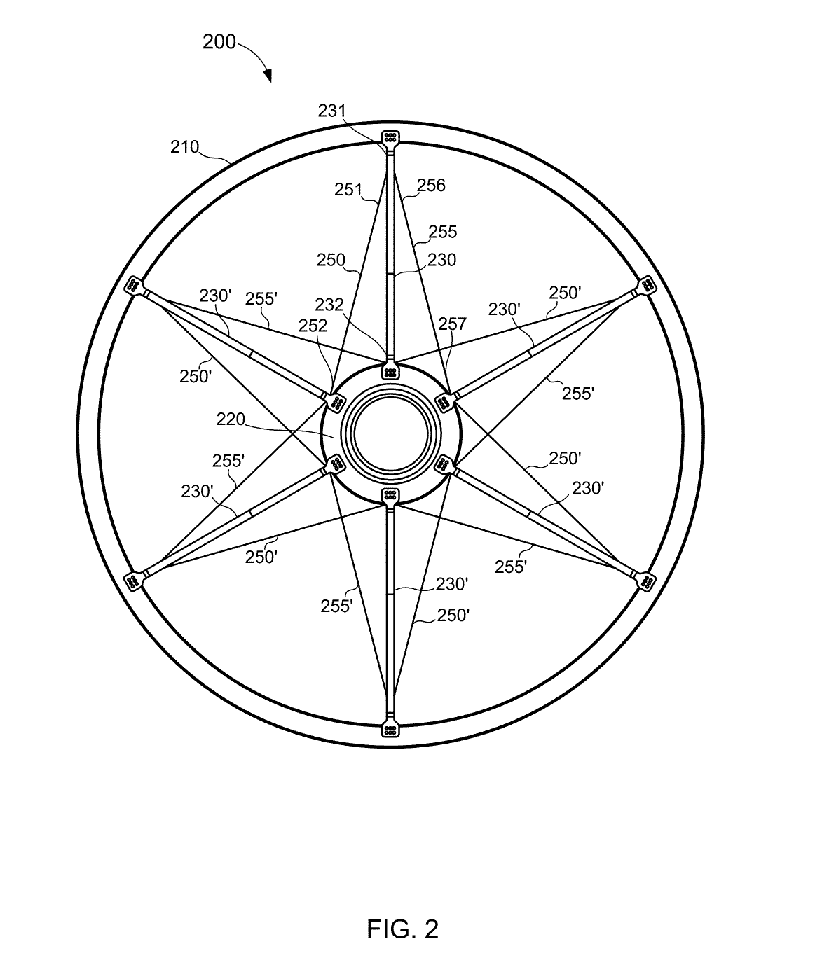

FIG. 2 depicts a generator structure 200, according to an embodiment. The generator structure 200 includes an outer support member 210, an inner support member 220, an elongate compression member 230 (also referred to herein as a “structural member” or “compression member”), a first elongate tension member 250, and a second elongate tension member 255 (also referred to herein as a “first tension member” and a second tension member, respectively). The outer support member 210, the inner support member 220, the compression member 230, and/or the tension member(s) 250, 255 can each be similar to the generator structure 100, the first support member 110, the second support member 120, the structural members 130, and/or the tension member 150, respectively, as shown and described above with reference to FIG. 1. For example, the compression member(s) 230, 230′ can each include one or more cooling channels similar to the cooling channel(s) 135, as described in more detail below with reference to specific embodiments. Although this embodiment, and other embodiments described below, includes tension members, such tension members are not required to be used in conjunction with structural members that incorporate or support the disclosed cooling channels. Rather, the cooling channels can be used in conjunction with any suitable machine structure.

As shown in FIG. 2, the generator structure 200 further includes a series of compression members 230′, first tension members 250′, and second tension members 255′. The compression members 230′ and the tension members 250′ and 255′ are substantially similar to the compression member 230 and the tension members 250 and 255, described in further detail herein. Therefore, the compression members 230′ and the tension members 250′ and 255′ are not described in further detail herein. Furthermore, the generator structure 200 can include any number of compression members and tension members. For example, in this embodiment, the generator structure 200 includes six compression members (230 and 230′), six first tension members (250 and 250′), and six second tension members (255 and 255′). In other embodiments, a generator structure can include more or less than six. For example, in some embodiments, a generator structure can include three, four, five, seven, eight, nine, ten, eleven, twelve, or more. In still other embodiments, a generator structure can include less than six compression members and first and second tension members.

The generator structure 200 can be any suitable structure included in an electromagnetic machine. For example, in this embodiment, the generator structure 200 is a stator. As described above in reference to FIG. 1, the outer support member 210 can support a set of PCBs configured to substantially encapsulate a set of windings. Similarly, the inner support member 220 can be any suitable structure such as, for example, a hub.

The compression member 230 includes a first end portion 231 and a second end portion 232 and is configured to extend between the outer support member 210 and the inner support member 220. The compression member 230 can be any suitable shape, size, or configuration. For example, in some embodiments, the compression member 230 can have a substantially rectangular or square cross-section. The first end portion 231 of the compression member 230 is coupled to the outer support member 210 and the second end portion 232 of the compression member 230 is coupled to the inner support member 220. More specifically, the first end portion 231 and the second end portion 232 can be any suitable shape and/or include any suitable structure to couple to the outer support member 210 and the inner support member 220, respectively, and simultaneously convey a cooling medium. For example, in some embodiments, the first end portion 231 and the second end portion 232 can form a flange configured to mate with a portion of the outer support member 210 and a portion of the inner support member 220, respectively. In some embodiments, the first end portion 231 and the second end portion 232 can be bolted to the outer support member 210 and the inner support member 220, respectively. In other embodiments, the end portions 231 and 232 can be riveted, welded, pinned, adhered, or any combination thereof.

The first tension member 250 includes a first end portion 251 coupled to a portion of the compression member 230 and a second end portion 252 coupled to the inner support member 220 or a portion of an adjacent compression member 230′. Similarly, the second tension member 255 includes a first end portion 256 coupled to a portion of the compression member 230 and a second end portion 257 coupled to the inner support member 220 of a portion of an adjacent compression member 230′. As shown in FIG. 2, the first tension member 250 is coupled to a first side of the compression member 230 and the second tension member 255 is coupled to a second side of the compression member 230, substantially opposite the first side.

The first tension member 250 and the second tension member 255 can be any suitable shape, size, or configuration. For example, in some embodiments, the first tension member 250 and the second tension member 255 are cable (e.g., steel braided cable or the like). In some embodiments, the first tension member 250 and the second tension member 255 can be substantially similar. In other embodiments, for example, the first tension member 250 and the second tension member 255 can have different shapes, sizes and/or configurations. For example, the first tension member 250 and the second tension member 255 can be cables and can have a different diameter (e.g., the cables are of a different diameter, thickness, or perimeter).

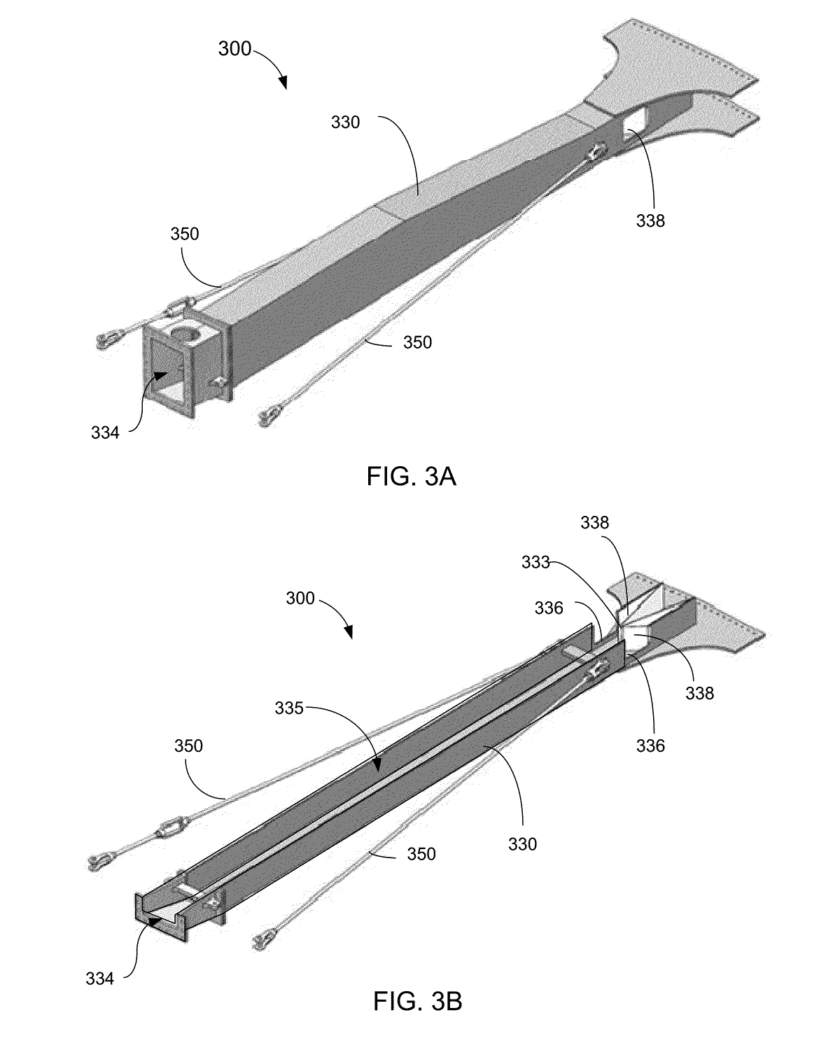

FIG. 3A is a perspective view of a portion of a generator structure 300, and FIG. 3B is a cross sectional view of the portion of the generator structure 300. The generator structure 300 can include the same or similar components and function the same as or similar to the generator structures 100 and 200 described above. For example, the generator structure 300 includes one or more structural members 330 that can be similar to the structural member(s) 130, 230, 230′ described above. For example, the structural member 320 can be disposed between and coupled to an inner support member (not shown in FIGS. 3A and 3B) and an outer support member (not shown in FIGS. 3A and 3B) of an electromagnetic machine. The generator structure 300 also includes two tension members 350 that can be similar to the tension members 150, 250, 250′, and/or 255, 255′ as shown and described above with reference to FIGS. 1 and 2.

In this embodiment, the structural member 330 defines a cooling channel 335, a first opening 334 on a first end portion of the structural member 330 and a pair of second openings 336 on a second end portion of the structural member 330, each in fluid communication with the cooling channel 335. As described above for previous embodiments, a cooling medium can enter the cooling channel 335 via the first opening 334, be conveyed through the cooling channel 335, and exit through the second openings 336. Thus, in this embodiment, the cooling medium can be conveyed, for example, in a radial direction from near an inner support member toward an outer support member of the generator structure 300. Alternatively, the cooling medium can be conveyed through the second openings 336, through the cooling channel 335 and exit the first opening 334. Thus, in such an embodiment, the cooling flow is in a radial direction from near the outer support member toward an inner support member of the generator structure 300. Two flow guides 338 are disposed on the second end of the structural member 330 and can direct the cooling medium through the second opening 336 and through an opening 333 defined between the two flow guides 338. In this embodiment, the cooling system is an open-loop system in that the cooling medium exits the opening 334 or 336, 333 and flows freely over and/or through a portion of the generator structure and/or the electromagnetic machine.

Although not shown in FIGS. 3A and 3B, the generator structure 300 can include a forcing mechanism and source of cooling medium as described above for previous embodiments. The generator structure 300 can also include one or more heat transfer members to further increase cooling of the generator structure and/or the electromagnetic machine.

FIG. 4A is a perspective view, and FIG. 4B is a cross sectional view of a portion of a generator structure 400, according to another embodiment. The generator structure 400 can include the same or similar components and function the same as or similar to the generator structures 100, 200 and 300 described above. For example, the generator structure 400 includes one or more structural members 430 that can be similar to the structural member(s) 130, 230, 230′, 330 described above. For example, the structural member 430 can be disposed between and coupled to an inner support member (not shown in FIGS. 4A and 4B) and an outer support member 410 of an electromagnetic machine. The generator structure 400 also includes two tension members 450 that can be similar to the tension members described above for previous embodiments.

In this embodiment, the structural member 430 defines a cooling channel 435, a first opening 434 defined on a first end portion of the structural member 430 and a second opening 436 defined on a second end portion of the structural member 430, each in fluid communication with the cooling channel 435. As described above for previous embodiments, a cooling medium can enter the cooling channel 435 via the first opening 434, and be conveyed through the cooling channel 435, and exit through the second opening 436. Thus, in this embodiment, the cooling medium can be conveyed, for example, in a radial direction from an inner support member to an outer support member of the generator structure 400.

As with generator structure 300, the generator structure 400 includes flow guides 438 disposed on the second end of the structural member 430 and that can direct the cooling medium towards the second opening 436. In this embodiment, the generator structure 400 also includes flow guide 440. The flow guides 440 can distribute the flow of cooling medium over a desired region of the generator structure 400.

As with the generator structure 300, in this embodiment, the cooling system is an open-loop system in that the cooling medium exits the opening 436 and flows freely over and/or through a portion of the generator structure and/or the electromagnetic machine.

Although not shown in FIGS. 4A and 4B, the generator structure 400 can include a forcing mechanism and source of cooling medium as described above for previous embodiments. The generator structure 400 can also include one or more heat transfer members to further increase cooling of the generator structure and/or the electromagnetic machine.

FIG. 5 is a schematic illustration of a portion of a generator structure according to another embodiment. A generator structure 500 can include the same or similar components and function the same or similar as the generator structures described above. For example, the generator structure 500 includes an inner support 520, an outer support 510 and one or more structural members 530 and 530′. Only two structural members 530 and 530′ are illustrated in FIG. 5, but it should be understood that the generator structure 500 can include more structural members, for example, as shown and described for generator structure 200 in FIG. 2. The structural members 530 and 530′ can each be disposed between and coupled to the inner support member 520 and the outer support member 510.

As shown in FIG. 5, the structural member 530 defines a first cooling channel 535 and the structural member 530′ defines a second cooling channel 537. The first cooling channel and the second cooling channel are in fluid communication with each other via a connection pathway 539 defined by a connection member 542. The connection member 542 can be coupled to the structural member 530 and the structural member 530′. In alternative embodiments, a connection pathway can be defined by the outer support member 510. The connection pathway 539 can be any pathway operable to allow passage of a cooling medium between the first cooling channel 535 and the second cooling channel 537. For example, the cooling medium can be conveyed in a radial direction from the inner support member 520 towards the outer support member 510 via the first cooling channel 535 of the structural member 530, flow through the connection pathway 539 and return via the second cooling channel 537 of the structural member 530′. Thus, in this embodiment, the generator structure 500 provides a return path for the cooling medium, which may be used in, for example, a closed loop cooling system.

Although not shown in FIG. 5, the generator structure 500 can include a forcing mechanism and source of cooling medium as described above for previous embodiments. The generator structure 500 can also include one or more heat transfer members to further increase cooling of the generator structure and/or the electromagnetic machine.

FIG. 6 is a cross-sectional view of a structural member that includes a separate component that defines a cooling channel(s). A structural member 630 can be formed the same as or similar to the structural members described herein. In this embodiment, the structural member 630 defines an interior channel 635 in which one or more cooling pipes can be disposed. As shown in FIG. 6, a cooling pipe 644 is disposed within the interior channel 635 and defines a cooling channel 645. The cooling channel 645 can be in fluid communication with the interior channel 635 of the structural member 630. For example, the cooling pipe 644 can define an opening at an end portion near an outer support member (not shown) or near an inner support member (not shown) (or other location along the cooling pipe 644). A cooling medium can be conveyed through the interior channel 635 of the structural member 630 and return through the cooling channel 645 of the cooling pipe 644, and vice versa. Thus, the cooling pipe 644 can be part of a closed loop cooling system.

In some embodiments, two cooling pipes can be used. For example, a first cooling pipe can be used as the delivery channel for the cooling medium and the second cooling pipe can be used as the return path for the cooling medium. In such an embodiment, the two cooling pipes can be formed as two separate components coupled together with a connection or as a single cooling pipe that is bent, curved or otherwise formed such that the cooling pipes are disposed along side each other. In an alternative embodiment, a single cooling pipe can be included and used as an open loop cooling system. For example, in such an embodiment, the cooling medium can flow in a radial direction through the cooling pipe and exit, for example, at an end portion near an outer support member or an inner support member.

FIG. 7 illustrates another example of a structural member that provides a return path for a cooling medium of a cooling system. In this embodiment, a structural member 730 can define dual cooling channels fluidly connected at an end portion of the structural member 730. As shown in FIG. 7, the structural member 730 defines a first cooling channel 735, a second cooling channel 737 and a connection pathway 749. A cooling medium can be delivered to either the cooling channel 735 or the cooling channel 737, flow through the connection pathway 749, and return through the other of the first cooling channel 735 and the second cooling channel 737. In yet another alternative embodiment, a structural member can be constructed of a number of tubular members (e.g., a bundle of pipes), such that each tubular member defines a flow channel.

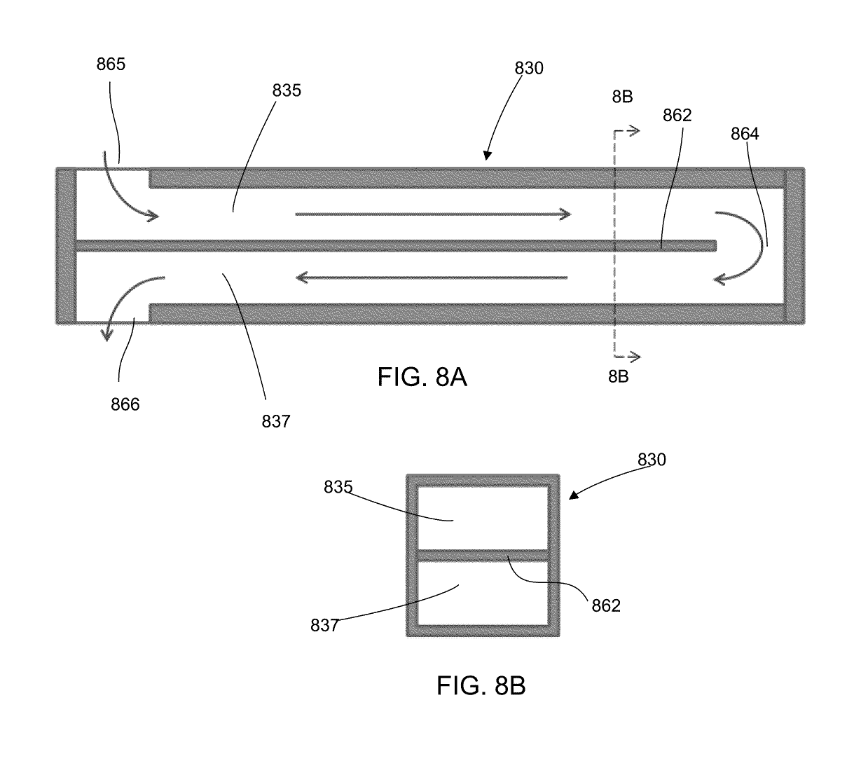

FIGS. 8A and 8B illustrate yet another example of a structural member that can provide a return path for a cooling medium of a cooling system. In this embodiment, a structural member 830 includes a baffle or wall 862 that separates an interior region of the structural member 830 into a first cooling channel 835 and a second cooling channel 837. A connection pathway 864 defined at an end portion of the structural member 830 provides a path of fluid communication between the first cooling channel 835 and the second cooling channel 837. The structural member 830 defines an opening 865 in fluid communication with the cooling pathway 835 and an opening 866 in fluid communication with the cooling pathway 837. As shown by the directional arrows in FIG. 8A, a cooling medium can be introduced through the opening 865, flow through the cooling channel 835, through the connection pathway 864, and return through the cooling channel 837, and exit through the opening 866. Alternatively, a cooling medium can be introduced through the opening 866, flow through the cooling channel 837, through the connection pathway 864, and return through the cooling channel 835, and exit through the opening 865.

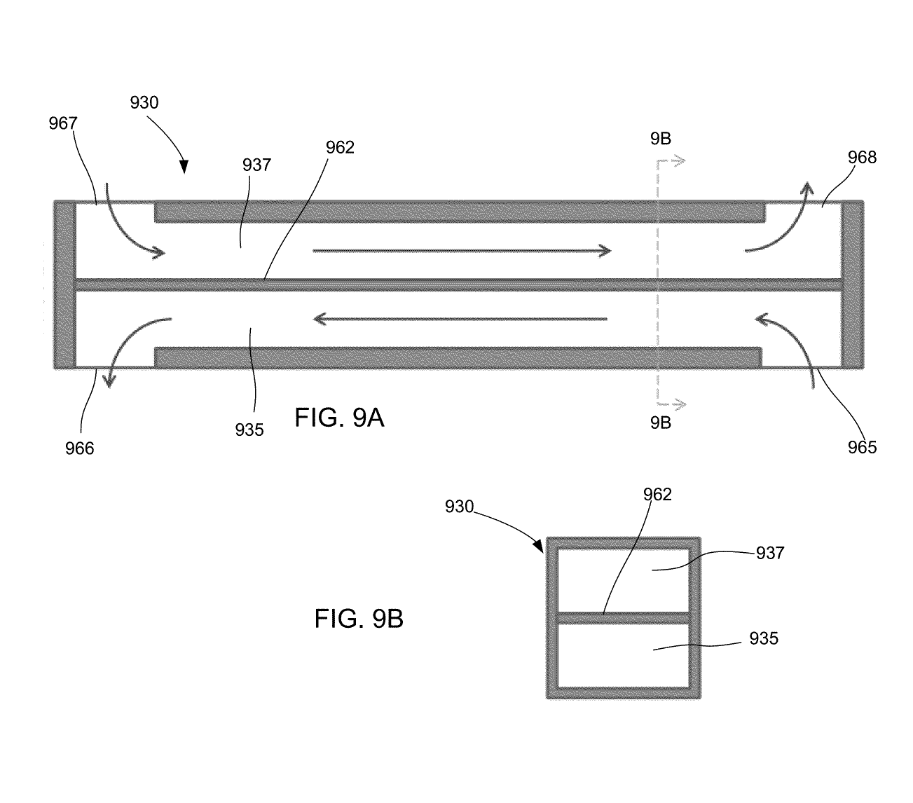

FIGS. 9A and 9B illustrate an embodiment of a structural member that provides multiple flow paths, which may divide cooling medium flow in a single direction, or provide a return path for the cooling medium. In this embodiment, a structural member 930 includes a baffle or wall 962 that separates the structural member 930 into a first cooling channel 935 and a second cooling channel 937. The structural member 930 defines an opening 965 and an opening 966 each in fluid communication with the cooling channel 935. The structural member 930 also defines an opening 967 and an opening 968 each in fluid communication with the cooling channel 937. As shown by the directional arrows in FIG. 9A, a cooling medium can flow into the opening 965, through the cooling channel 935, and exit through the opening 966. Similarly, a cooling medium can flow into the opening 967, through the cooling channel 937, and exit through the opening 968. Thus, the structural member 930 can accommodate a two directional flow of cooling medium within the cooling channels 935, 937. Alternatively, the flow of cooling medium can be in the same direction within the cooling channels 935, 937.

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described. For example, although some embodiments are shown and described as having flow guides positioned adjacent to an outlet of a cooling channel, in addition or alternatively, flow guides can be positioned adjacent to an inlet of a cooling channel, along the length of the flow channel, and/or in any other suitable position to, for example, direct a flow and/or reduce pressure losses of a cooling medium.

In addition, it should be understood that the features, components and methods described herein for each of the various embodiments can be implemented in a variety of different types of electromagnetic machines, such as, for example, axial and radial machines that can support rotational movement of a rotor assembly relative to a stator assembly.

What is claimed is:

1. An apparatus, comprising:
a structure for an electromagnetic machine including:
a first support member configured to support one of a conductive winding or a magnet;
a second support member disposed at a non-zero distance from the first support member; and
an elongate structural member having a first end coupled to the first support member and a second end coupled to the second support member, the elongate structural member extending between the first support member and the second support member,
the elongate structural member defining an interior channel extending between the first end and the second end of the elongate structural member, the channel configured to convey a cooling medium therethrough to cool at least a portion of the electromagnetic machine.

2. The apparatus of claim 1, wherein the elongate structural member is configured to resist at least one of radial, axial or rotational deflection of the first support member relative to the second support member.

3. The apparatus of claim 1, wherein the cooling medium is one of a gas, a liquid and a two-phase medium.

4. The apparatus of claim 1, further comprising:
a flow guide coupled to the elongate structural member, the flow guide configured to direct a flow of the cooling medium entering or exiting the channel.

5. The apparatus of claim 1, further comprising:
a flow guide coupled to the elongate structural member, the flow guide configured to direct a flow of the cooling medium within the channel.

6. The apparatus of claim 1, further comprising:
a forcing mechanism fluidically coupled to at least one of the first end or the second end of the elongate structural member and configured to increase a flow of the cooling medium within the channel.

7. The apparatus of claim 1, further comprising:
a heat transfer member thermally coupled to the elongate structural member and to the cooling medium and configured to transfer heat from the cooling medium.

8. The apparatus of claim 1, further comprising:
an outlet defined at one of the first end and the second end of the elongate structural member in fluid communication with the channel, the cooling medium configured to exit the channel at the outlet.

9. The apparatus of claim 1, wherein the first support member is an outer support member, the second support member is an inner support member and is disposed at a non-zero radial distance from the first support member, and the structural member extends radially between the outer support member and the inner support member.

10. An apparatus, comprising:
a structure for an electromagnetic machine including:
a first support member configured to support one of a conductive winding or a magnet;
a second support member is disposed at a non-zero distance from the first support member; and
an elongate structural member having a first end coupled to the first support member and a second end coupled to the second support member, the elongate structural member extending between the first support member and the second support member,
the elongate structural member defining a first interior channel extending between the first end and the second end of the elongate structural member and a second interior channel in fluid communication with the first interior channel and extending between the first end and the second end of the elongate structural member,
the first interior channel configured to convey a cooling medium in a first direction, the second interior channel configured to receive the cooling medium from the first interior channel and convey the cooling medium in a second direction opposite the first direction, the cooling medium configured to cool at least a portion of the electromagnetic machine.

11. The apparatus of claim 10, wherein the elongate structural member defines an inlet at one of the first end and the second end of the elongate structural member in fluid communication with the first interior channel, the inlet configured to receive a flow of cooling medium therethrough.

12. The apparatus of claim 10, wherein the cooling medium is one of a gas, a liquid and a two-phase medium.

13. The apparatus of claim 10, further comprising:
a flow guide coupled to the elongate structural member, the flow guide configured to direct a flow of the cooling medium entering or exiting the channel.

14. The apparatus of claim 10, further comprising:
a flow guide coupled to the elongate structural member, the flow guide configured to direct a flow of the cooling medium within the channel.

15. The apparatus of claim 10, further comprising:
a forcing mechanism fluidically coupled to at least one of the first end or the second end of the elongate structural member and configured to increase a flow of the cooling medium within the channel.

16. The apparatus of claim 10, further comprising:
a heat transfer member thermally coupled to the elongate structural member and to the cooling medium and configured to transfer heat from the cooling medium.

17. The apparatus of claim 10, wherein the first support member is an outer support member, the second support member is an inner support member and is disposed at a non-zero radial distance from the first support member, and the structural member extends radially between the outer support member and the inner support member.

18. The apparatus of claim 10, wherein the first interior channel is configured to convey a cooling medium in a first radial direction, the second interior channel is configured to receive the cooling medium from the first interior channel and convey the cooling medium in a second radial direction opposite the first direction,

19. An apparatus, comprising:
a structural cooling device for an electromagnetic machine including:
an elongate structural member having a first end couplable to an inner support member of the electromagnetic machine, and a second end couplable to an outer support member of the electromagnetic machine, the elongate structural member extending radially between the inner support member and the outer support member and configured to resist at least one of radial, axial or rotational deflection of the outer support member relative to the inner support member when coupled thereto,
the elongate structural member defining an interior channel extending between the first end and the second end of the elongate structural member and configured to receive a cooling medium therethrough; and
a source of cooling medium couplable to the elongate structural member and configured to convey the cooling medium to the interior channel of the elongate structural member, the cooling medium configured to cool at least a portion of the electromagnetic machine.

20. The apparatus of claim 19, wherein the cooling medium is one of a gas, a liquid and a two-phase medium.

21. The apparatus of claim 19, further comprising:
a flow guide coupled to the elongate structural member, the flow guide configured to direct a flow of the cooling medium entering or exiting the interior channel.

22. The apparatus of claim 19, further comprising:
a flow guide coupled to the elongate structural member, the flow guide configured to direct a flow of the cooling medium within the interior channel.

23. The apparatus of claim 19, further comprising:
a forcing mechanism fluidically coupled to at least one of the first end or the second end of the elongate structural member and configured to increase a flow of the cooling medium within the channel.

24. The apparatus of claim 19, further comprising:
a heat transfer member thermally coupled to the elongate structural member and to the cooling medium and configured to transfer heat from the cooling medium.

25. The apparatus of claim 19, wherein the interior channel is a first interior channel, the elongate structural member further defines a second interior channel in fluid communication with the first interior channel and extending between the first end and the second of the elongate structural member,
the first interior channel configured to convey the cooling medium from the source of cooling medium in a first radial direction, the second interior channel configured to receive the cooling medium from the first interior channel and convey the cooling medium in a second radial direction opposite the first direction.
